(19) United States
(12) Patent Application Publication
(10) Pub. No.: US 2009/0035445 A1
(43) Pub. Date: Feb. 5, 2009

(54) Modified Protein-Based, Low-Carbohydrate Food Ingredient and Process for Making Same

(76) Inventors: Christopher R. Daubert, Apex, NC (US); Prabhasankar Pichan, Mysore (IN); Debra A. Clare, Cary, NC (US); Stephen Jonathan Lillard, Toronto (CA)

Correspondence Address: MYERS BIGEL SIBLEY & SAJOVEC, PO BOX 37428, RALEIGH, NC, 27627, US

(21) Appl. No.: 11/832,729

(22) Filed: Aug. 2, 2007

(51) Int. Cl. A23J 3/00

(52) U.S. Cl. 426/656

(57) ABSTRACT

A process for producing a protein-carbohydrate complex includes the steps of providing a modified protein (MP), the MP characterized by being denatured and heated sufficiently to gel; mixing the MP with a carbohydrate to form an MP-carbohydrate mixture; and heating the MP-carbohydrate mixture to a temperature and for a time sufficient to form MP-carbohydrate complexes. The resulting protein-carbohydrate complex may have properties that include a viscosity of at least 1.0 Pa-s at a shear rate of a 50 s⁻¹ at 25° C. and a creaming index of less than 25 percent.

### FIELD OF THE INVENTION

The present invention relates generally to food additives, and more particularly to protein-carbohydrate complexes.

### BACKGROUND OF THE INVENTION

Proteins and polysaccharide mixtures are found among the ingredients in a wide range of colloidal food systems, ranging from mayonnaise to ice cream. Proteins primarily function as emulsion-forming and stabilizing agents, whereas polysaccharides serve as thickening and water-holding agents. The control or manipulation of macromolecular interactions between them can be a key factor in the development of novel food processes and ingredients, as well as in the formulation of fabricated foods. The overall stability and texture of these colloidal systems can depend not only on the functional characteristics of individual ingredients, but also on the nature and strength of protein-polysaccharide interactions. Dickinson, E. In: Food Polysaccharides; A. M. Stephen, A. M., Ed.; Marcel Dekker; New York, 1995; p 501.

In the past, numerous chemical and enzymatic methods were developed to improve the functionality of proteins; however, most of these procedures were not appropriate for food applications because of potential health hazards and food safety concerns. Such disadvantages may be circumvented by covalently linking the ε-amino group of proteins with the reducing-end of various polysaccharides under controlled beating conditions via the Maillard reaction. Kato, A. Preparation and functional properties of protein-polysaccharide conjugates. In Surface activity of proteins: Chemical and physicochemical modification; Magdassi, S., Ed.; Marcel Dekker; New York, 1996; pp 115-129.

In previous research, whey proteins were linked to dextran (see, Dickinson, E.; Galazka, V. B. Emulsion stabilization by ionic and covalent complexes of β-lactoglobulin with polysaccharides. Food Hydrocolloids 1991, 5, 281-296; Dickinson, E.; Semenova, M. G. Emulsifying properties of covalent protein-dextran hybrids. Colloids and Surfaces, 1992, 64, 299-310; Akhtar, M.; Dickinson, E. Emulsifying properties of whey protein-Dextran conjugates at low pH and different salt concentrations. Colloids and Surfaces B: Bio interfaces, 2003, 31, 125-132; Kato, A.; Mifuru, R.; Matsudomi, N.; Kobayashi, K. Functional casein-polysaccharide conjugates prepared by controlled by heating. Biosci. Biotech. Biochem., 1992, 56, 567-571), galactomannan (see, Aktar et al., supra; Kato et al., supra; Matsudomi, N.; Inoure, Y.; Nakashima, H.; Kato, A.; Kobayashi, K. Emulsion stabilization by Maillard-type covalent complex of plasma protein with galactomannan. J. Food Sci., 1995, 60, 265-268), low methoxyl pectin (see, Mishra, S., Mann, B.; Joshi, V. K. Functional improvement of whey protein concentrate on interaction with pectin. Food Hydrocolloids, 2001, 15, 9-15), carboxymethyl cellulose (see, Difitis, N.; Kiosseoglou, V. Improvement of emulsifying properties of soybean protein isolate by conjugation with carboxymethyl cellulose. Food Chem., 2003, 81, 1-16, or maltodextrin (see, Shepherd, R.; Robertson, A.; Ofman, D. Dairy glycoconjugate emulsifiers: Casein-maltodextrin. Food Hydrocolloids, 2000, 14, 281-286. Resultant glycoprotein conjugates subsequently exerted an important influence on the structure and stability of the food systems, see Dickinson, E.; McClements, D. J. Protein-polysaccharide interactions. In Advances in Food Colloids. Dickinson, E.; McClements, D. J.; Eds.; Blackie Academic and Professional: Glasgow, 1995; pp 81-101, used the conjugates as fat replacers, texturing agents, and emulsifiers.

In previous work, a modified whey protein (MWP) formulation was developed that displayed improved functional characteristics including gelation, emulsifying capacity, and visco-elastic properties over native whey proteins (see, U.S. Pat. No. 6,261,624 to Hudson et at.; see also Hudson, H. M.; Daubert, C. R.; Foegeding, E. A. Rheological and physical properties of modified whey protein isolate powders. J. Agric. Food Chem., 2000, 48, 3112-3119, and Hudson, H. M.; Daubert, C. R.; Functionality comparison between derivatized whey proteins and a pre-gelatinized starch. J. Textural Studies, 2002 33, 297-314).

### SUMMARY OF THE INVENTION

Embodiments of the present invention are directed to a process for producing a protein-carbohydrate complex. The process includes the steps of: providing a modified protein (MP), the MP characterized by being denatured and heated sufficiently to gel; mixing the MP with a carbohydrate to form an MP-carbohydrate mixture; and heating the MP-carbohydrate mixture to a temperature and for a time sufficient to form MP-carbohydrate complexes. The resulting MP-carbohydrate complex may have properties that include a two-fold increase in viscosity over an MP dispersion and a 82% and 71% increase in emulsion stabilization over protein solutions prepared with commercial whey protein concentrate and MP respectively.

Other embodiments of the present invention are directed to a modified protein-carbohydrate complex. The complex has a viscosity of at least 1.0 Pa-s at a shear rate of a 50 s⁻¹ at 25° C. and a creaming index of less than 25 percent.

### BRIEF DESCRIPTION OF THE FIGURES

FIG. 1 is a depiction of SDS-Polyacrylamide patterns of MWPC (modified whey protein concentrate), CWPC (control whey protein concentrate) and MWPC-Dextran conjugates (10-20% Tricine gel) stained with coomassie brilliant blue (Lanes: 1. Molecular weight marker; 2. MWPC; 3. CWPC; 4. MWPC-heated; 5. MWPC-Dextran (35 kDa); 6. MWPC-Dextran (200 kDa)

FIG. 2 is a depiction of SDS-Polyacrylamide patterns of MWPC, CWPC and MWPC-Dextran conjugates (10-20% Tricine gel) stained with glycoprotein staining kit (Lanes: 1. Molecular weight marker; 2. MWPC; 3. CWPC; 4. MWPC-heated; 5. MWPC-Dextran (35 kDa); 6. MWPC-Dextran (200 kDa)

FIG. 3 is a graph plotting viscosity as a function of shear rate for MWPC and MWPC-Dextran conjugates (35 kDa and 200 kDa) (25° C.).

FIG. 4 is a scanning electron micrograph (15,000×) of MWPC 5.6% (w/v) protein

FIG. 5 is a scanning electron micrograph (15,000×) of MWPC-Dextran (200 kDa).

FIG. 6 is a bar graph showing the emulsion stability of 0.5% protein (w/v) CWPC (labeled “Ultra”), MWPC, MWPC-heated, MWPC-Dextran 200 kDa and MWPC-Dextran 35 kDa solutions in a 1:1 ratio with corn oil.

### DETAILED DESCRIPTION OF EMBODIMENTS OF THE INVENTION

The present invention will now be described more fully hereinafter, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

As discussed above, the present invention is directed to the production of modified protein-carbohydrate complexes. The modified protein can be whey protein, but other sources of protein can also be used, particularly soy protein, egg albumin (including fresh, refrigerated, frozen or dried egg white), and meat proteins.

Whey protein is widely available as a by-product of the cheese manufacturing industry. Any whey protein can be used to carry out the present invention, including but not limited to dried whey powders or concentrated (i.e., liquid) whey preparations. Numerous techniques for manufacturing whey protein are known, including but not limited to those described in U.S. Pat. No. 4,036,999 to Grindstaff and U.S. Pat. No. 3,930,039 to Kuipers (the disclosures of all U.S. patents cited herein are to be incorporated herein by reference in their entirety). A commercial whey protein isolate containing approximately 91 percent (w/w) protein may be particularly suitable.

The protein is modified such that it has increased viscosity in solution; consequently, it may be employed as a thickening agent. The modification, described in detail in U.S. Pat. No. 6,261,624 to Hudson et al., supra, involves denaturing a solution of protein (typically via acid or enzymatic hydrolysis), then heating the denatured protein for a time and at a temperature sufficient to cause the protein to gel (typically at 70 to 80° C. for 5-6 hours). The modified protein may then be used in embodiments of the present invention in the form of the heated solution (typically an aqueous solution), as a subsequently cooled solution, or may be dried and used in another form, such as a powder or flake. As described in Hudson et al., once protein molecules have been heated to temperatures in which they unfold, they may either aggregate or remain unfolded as individual molecules, depending on the balance of attractive and repulsive interactions. In general, changes in the gelation environment may alter protein-protein and protein-solvent interactions by shifting the balance of attractive and repulsive forces (predominantly electrostatic and hydrophobic interactions and hydrogen bonding). The resulting gel has superior water retention properties, either in gel or powder form. For example, the modified protein exhibits a 65 fold increase in viscosity over a commercial whey protein concentrate at a representative 50 s⁻¹ shear rate at 25° C. and provides a 30% increase in emulsion stabilization. Also, the MP may have a viscosity of at least one-half Pa-s at 46 s⁻¹ for one half hour in a steady state shear test at 25° C. when reconstituted as a 10% weight/weight solution in deionized water at a pH of 4. Further, the MP may have a phase angle of five to forty degrees at frequencies of from 0.01 to 20 Hertz in a frequency sweep test at 25° C. when reconstituted as a 10% weight/weight solution in deionized water.

The modified protein is mixed with a carbohydrate. The carbohydrate can be any known reducing carbohydrate that can react in a Maillard reaction with the free amino group of a protein to form a modified protein-carbohydrate complex. Exemplary carbohydrates include dextran, lactose (which may be present in the modified protein mixture, particularly when the modified protein was formed from a whey protein concentrate), glucose (from, for example, corn syrup), and ribose. In some embodiments, the carbohydrate is added to the modified protein in an amount between 1:1 and 3:1 by weight; in further embodiments, the carbohydrate is added to the modified protein in an amount between about 1.5:1 and 2.5:1 by weight.

Mixing may be carried out under any conditions that allow the Maillard reaction to occur. In some embodiments, the mixing is carried out at an acidic pH, with a pH between about 3 and 4 being typical; in certain embodiments the pH is between about 3.3 and 3.6.

The modified protein and carbohydrate are heated to a temperature and for a time sufficient to induce the Maillard reaction to occur. Heating under dry conditions in the water activity range of 0.3 to 0.7 will allow for the greatest reaction rate. Water activity is specifically defined as a_{w}=p/p_{0,} where a_{w} represents the water activity, p is the partial pressure of water, and p₀, is the vapor pressure of pure water at the same temperature. (There are inherent differences with respect to the degree with which water molecules associate with nonaqueous constituents and such properties can impact the potential degradation of a food component. For example, if the amount of bound water is high, this means that less free water is made available to support microbial growth. In general, water activity is one of the parameters used in determining perishability.)

In some embodiments, the reaction is carried out at a temperature of between about 60 and 90° C. (70 to 80° C. being more typical) for a duration of between about 2-10 hours (4 to 6 hours being more typical). In addition, conformational changes in the protein allow basic residues (e.g., lysine groups) to covalently bond, which can increase protein-carbohydrate conjugation and prevent dissociation. Typically, the reaction causes at least 25 percent of the modified protein's reactive amino groups to covalently bond with the carbohydrate.

In some embodiments, the mixing and heating steps are carried out in the absence of enzymatic agents (in contrast to other processes in which protein-carbohydrate complexes are formed). In other embodiments, the mixing and heating steps are carried out in the absence of chemical reagents such as cyanoborohydride or 1-ethyl-3-[(3-dimethylamino)-propylcarbodiimide (EDC) hydrochloride.

It should also be noted that the carbohydrate may be added to the protein prior to modification of the protein, such that the heating steps that modify and eventually dry the protein ingredient also cause the Maillard reaction to occur.

Once formed, the modified protein-carbohydrate complex can be used as is, or can be converted to another form, such as a powder, pellet, flake or the like. In some embodiments, the modified protein-carbohydrate complex is dried, then formed into a powder or flake. This process may be carried out by, for example, spray drying. In fact, in some embodiments, the heating and drying steps can be combined in a heated spray-drying process. When formed as a dry powder, the modified protein-carbohydrate complex can be packaged in screw-top or sealed polymeric containers for consumer use in accordance with known techniques, or can be rehydrated in an aqueous liquid and provided as a liquid concentrate to consumers or other end users.

Complexes according to embodiments of the present invention may have a viscosity of greater than 1 Pa-s at 50 s⁻¹ and a creaming index of less than 25 percent, and in some embodiments less than 15 percent. The modified protein-carbohydrate complex at a ratio of 2:1 with a protein concentration of 7% (w/v) can have the properties set forth in Table 1:

TABLE 1

| Property | Amount |
|---|---|
| Viscosity at 50 s⁻¹ | 1-5 Pa-s |
| Creaming Index Value (1 week ambient) | <25% |

With these properties, the modified protein-carbohydrate complex may be combined with foodstuffs to thicken them. In addition, the modified protein-carbohydrate complex may serve as a stabilizer or emulsifier in such foodstuffs.

The modified protein-carbohydrate complex described above can be combined with other ingredients, such as emulsifying agents, stabilizing agents, anti-caking, anti-sticking agents and the like. Representative stabilizing agents are gums, which include naturally occurring plant polysaccharides such as obtained from trees, seeds, seaweed and microbes, including gum arabic, acacia, tragacanth, karaya, larch, ghatti, locust, guar, agar, algin, carrageenan, furacellaran, xanthan, pectin, certain proteins such as gelatins, plus certain chemical derivatives of cellulose.

Specific examples of food products that can be prepared with the dry powder protein preparation described herein include dessert products or dairy products such as ice cream, custard or the like; cooked products or flour-based products such as bread, cookies, brownies, cheese cake, pie, other snack foods and the like; beverages such as a milk shake or other shake, fruit juices and the like; a health supplement, nutritional supplement, or medical food product such as a beverage or bar; sauces, dips, spreads, icings and cream pie fillings and the like. The typical solid food product will constitute from 1 or 2 percent to 50, 60, or 70 percent by weight water (from all sources), or more. The typical liquid (including thickened liquid) food product will typically constitute 40 or 50 percent to 90, 95 or even 99 percent by weight water (from all sources). Other ingredients of a solid food product will typically constitute from 10 or 20 percent to 50, 60 or 70 percent by weight. Other ingredients of a liquid (including thickened liquid) food product will typically constitute from 1 or 2 percent up to 40 or 50 percent by weight, and occasionally more. These percentages are provided as general guidelines only; sometimes water is included in the weight of “dry” ingredients which are not fully dehydrated, and of course in no case do the total amounts of all ingredients exceed 100 percent; thus, it is preferred to define food products of the invention simply by reference to the amount by weight of the modified protein-carbohydrate complex added thereto.

The invention is described in greater detail in the following non-limiting examples.

### EXAMPLE 1

### Materials

A MWP ingredient prepared according to the method of Hudson et al., supra. was obtained from Grande Custom Ingredients, Inc. (Grande Custom Ingredients Group, Lomira, Wis.). The MWP contained approximately 70.4% (w/w) protein and 7% lactose (w/w) and was used for all experiments. A commercial whey protein concentrate labeled Ultra 8000 was also obtained from Grande Custom Ingredients (Lomira, Wis.) for comparison purposes. Nitrogen content of the MWPC was analyzed by the Analytical Services Laboratory (Raleigh, N.C.) using a CHN Elemental Analyzer, Series II (Perkin Elmer Corporation, headquartered in Norwalk, Conn.). Protein content was calculated from the provided value using the equation (N×6.38) (Table 2). Dextran (35 kDa-200 kDa) from leuconostoc mesenteroides was obtained from Sigma-Aldrich (St. Louis, Mo.). A Bicinchoninic Acid (BCA) Protein assay kit, o-Phthalaldehyde (OPA) Assay reagent, and Glycoprotein staining kit were obtained from Pierce (Rockford, Ill.). Precast Tricine SDS-Polyacrylamide (10-20%) Gradient Gels and a Colloidal Blue staining kit were obtained from Invitrogen Life Technologies (Carlsbad, Calif.).

TABLE 2

| | Protein^{a} | Moisture^{b} | Ash^{b} | Fat^{b} | Carb^{b} |
|---|---|---|---|---|---|
| Sample | (%) | (%) | (%) | (%) | (%) |
| MWPC | 70.37 | 4.56 | 2.7 | 4.81 | 9.29 |

^{a}Determined by micro-Kjeldahl (N × 6.38)
^{b}Provided by Grande Custom Ingredients Group

### EXAMPLE 2

### Preparation of MWP-CHO Complexes

Under acidic pH conditions, the nucleophilic amino groups of MWP are attacked by electrophilic carbonyl groups of polysaccharides through electrostatic attractions. Nurston, H. 2005. The Maillard reaction; chemistry, biochemistry, and implications. Royal Society of Chemistry. pp 7-8. Prolonged heat treatment further induces protein conformational changes, exposing reactive basic residues leading to increased covalent bonding. As a result, protein-carbohydrate conjugation is induced, thereby preventing dissociation. Ledward, D. A. Protein-polysaccharide interactions. In Protein functionality in food system N. S. Hettierachchy, N. S.; Ziegler, G. R., Ed.; Marcel Dekker, New York, 1994; pp 225-259; see also Samant, S.; Singhal, R.; Kulkarn, P. R.; Rage, D. Review: Protein-polysaccharide interactions: a new approach in food formulations. Int. J. Food Sci. Tech., 1993, 28, 247-562.

Initially, investigation into the appropriate ratio of protein to carbohydrate was determined by dissolving stock solutions of MWPC powder and dextran (100-200 kDa) in deionized (DI) water at three different protein to carbohydrate ratios (1:0, 2:1, and 3:1), with all dispersions containing 8% solids (w/v). Sample 1 contained a 1:0 ratio of MWPC alone dispersed in DI water to form a 5.6% protein (w/v) solution. Sample 2 contained a 2:1 mixture of MWPC to dextran dispersed in DI water to produce a 3.7% protein (w/v) concentration. Sample 3 contained a 3:1 ratio of MWPC to dextran dispersed in DI water to produce a 4.2% protein (w/v) concentration. The solutions were stirred on a stir plate at 150 rpm for 2 hours and the pH of each solution was adjusted to 3.5 with 6N HCl or NaOH. The solutions were then transferred to lyophilization vessels and attached to a 4.5 liter benchtop freeze dryer (Labconco, Kansas City, Mo.). The solutions were left to lyophilize for 48 hours. Once removed, the lyophilized powder was ground to obtain a fine powder and placed in 400 ml beakers for thermal treatment. The lyophilized powder was then heated in an Isotemp 630G convection oven (Fisher Scientific, USA) for 2 hours at 100° C. to form the glyco-conjugate. Measurement of the level of free amino groups present after thermal treatment determined the 2:1 ratio to provide the greatest level of conjugation; subsequent solutions containing dextran at 35 and 200 kDa (DX 35, DX 200) were made in accordance with these findings.

### EXAMPLE 3

### Determination of Protein Content in Samples

The bicinchoninic acid (BCA) assay is a colorimetric method for measuring protein concentration in a given sample. The first step is a Biuret reaction that reduces Cu⁺² to Cu⁺, followed by BCA forming a complex with Cu⁺¹ and producing a purple color detectable at 562 nm. Weichelmen, K. J., Braun, R. D., Fitzpatrick, J. D. 1988. Investigation of the bicinchoninic acid protein assay: identification of the groups responsible for color formation. Anal. Biochem. November 15; 175(1): 231-7.

All samples were hydrated in DI water for ≧24 hours at 4° C. prior to testing. The samples were diluted 1:30 (protein solution to DI water) to ensure they were in the acceptable range of 0 to 2 mg/ml to fit within the established standard curve. A standard curve was established by taking 5 test tubes containing 2 ml of BCA reagent and adding increasing amounts of albumin standard from 0 to 100 μl in increments of 25 μl. Deionized water was added to each tube used in the standard curve to bring the total volume to 2.1 ml. Then, 100 μl of the appropriately diluted sample containing unknown protein concentrations were added to 2 ml of BCA reagent. All samples were incubated at 37° C. for 30 minutes and the absorbance at A₅₆₂ nm was read for each sample using a Gilford Instruments 2600 UV-Visible, scanning spectrophotometer. This analysis was performed in duplicate. These values were used to calculate the amounts of protein remaining in each sample after treatments to ensure equal amounts of protein were evaluated amongst samples, so that any results were due to modifications and not variations of protein.

### EXAMPLE 4

### Color Measurement

Reflectance measurements of MWP and MWP-Dextran conjugates were performed using a Konica Minolta CR-300 Chroma Meter (Tequipment, Long Branch, N.J.) with diffuse illumination/0°. Measurements were performed on dry powdered samples and readings obtained from the Chroma Meter were based on the Hunter L, a, b scale and analyzed in triplicate. As can be seen in Table 3, the color parameters associated with the MWP-CHO complexes were different when compared to MWPC.

TABLE 3

| Sample | L* | a* | b* |
|---|---|---|---|
| MWPC | 97.92 | −0.74 | 7.19 |
| MWPC + Heat | 88.72 | 0.51 | 18.59 |
| DX 35 | 96.03 | −0.55 | 11.86 |
| DX 200 | 93.7 | −0.42 | 14.71 |

a +ve values: Red; a −ve values: Green;
b +ve values: Yellow; b −ve values: Blue;
L: white = 100, black = 0.
All the values represent an average of triplicate readings

This response may be due to formation of a dull brown color typically produced as result of the Maillard reaction (see Morris, G A.; Sims, I. M.; Robertson, A. J.; Furneaux, R. H. Investigation into the physical and chemical properties of sodium caseinate-maltodextrin glyco-conjugates. Food Hydrocolloids, 2004, 18, 1007-1014; see also Neirynck, N.; Van der Meeran, P.; Bayarii Gorbe, S.; Dierckx, S.; Dewettinck, K. Improved emulsion stabilizing properties of whey protein isolate by conjugation with pectin. Food Hydrocolloids, 2004, 18, 949-957). Similar observations were made upon visual inspection of MWPC powders versus MWPC-CHO powders. Morris et al. observed an increase in brown color formation during heat treatment of sodium caseinate with maltodextrin as a result of Maillard reactivity. Neirynck et al. recently reported an increase in brown colors using whey protein isolate with pectin as compared to a control (untreated whey protein isolate).

### EXAMPLE 5

### Degree of Conjugation

The degree of conjugation between MWP and carbohydrate was estimated using an o-Phthaldaldehye (OPA) procedure as described in Church, F. K.; Swaisgood, H. E.; Porter, D. H.; Catgnani, L. Spectrophotometeric assay using o-Phtaldialdehyde for determination of proteolysis in milk and isolated mile proteins. J Dairy Sci., 1983, 66, 1219-1227. The OPA reagent was purchased from Pierce (Rockford, Ill.). Two ml of the OPA reagent was added to either 50 μl of protein or 50 μl protein-carbohydrate conjugate, and the absorbance was measured at A₃₄₀ run after 5 min with all readings falling between 0.1 and 1.0. The OPA reagent itself served as the blank for each assay, and triplicate samples were quantified in this manner.

The OPA method quantified the degree of conjugation during protein-carbohydrate complex formation (see Chevalier; Morris, supra). The absorbance values of the MWPC-Dextran conjugates were lower than MWPC itself, suggesting covalent bond formation between the free amino groups of MWPC with the carbohydrate. This data indicated that heating with either lactose or dextran present greatly reduced the concentration of free amino groups of the MWPC due to covalent linkage with a carbohydrate (Table 4).

TABLE 4
Measurement of Free Amino Groups

| S. No | Sample | OD at 340 nm* | μM/mg of protein |
|---|---|---|---|
| 1 | MWPC | 0.905 | 298 |
| 2 | MWPC-Dextran (200 kDa) | 0.491 | 206 |
| 3 | MWPC-Dextran (35 kDa) | 0.458 | 272 |
| 4 | MWPC-Heated | 0.458 | 194 |

*All the values are average of triplicates.

### EXAMPLE 6

### Confirmation of Covalent Linkage

Sodium dodecyl sulfate-polyacrylamide gel electrophoresis (SDS-PAGE) was performed according to the method described in Laemmli, U.K. Cleavage of structural proteins during the assembly of the head of bacteriophage T4. Nature 1970, 227, 680, using Tricine 10-20% gradient polyacrylamide gels. Initially BCA analysis was performed to ensure equivalent amounts of protein were loaded into each lane of the Tricine gels. Samples were mixed with 0.9M Tris sample buffer containing 8% sodium dodecyl sulfate (SDS) and 5.0% β-mercaptoethanol, then heated at 100° C. for 10 min prior to loading onto the gels. Gels were run with a Novex Power Ease 500 Power Supply (Invitrogen Inc., Carlsbad, Calif.) for 85 min at 125V. After completion of electrophoresis, samples were stained for visualization of proteins using colloidal Coomassie Blue staining reagent (Invitrogen Inc., Carlsbad, Calif.) and glycoproteins were detected using a GelCode Glycoprotein Staining Kit (Pierce, Rockford, Ill.).

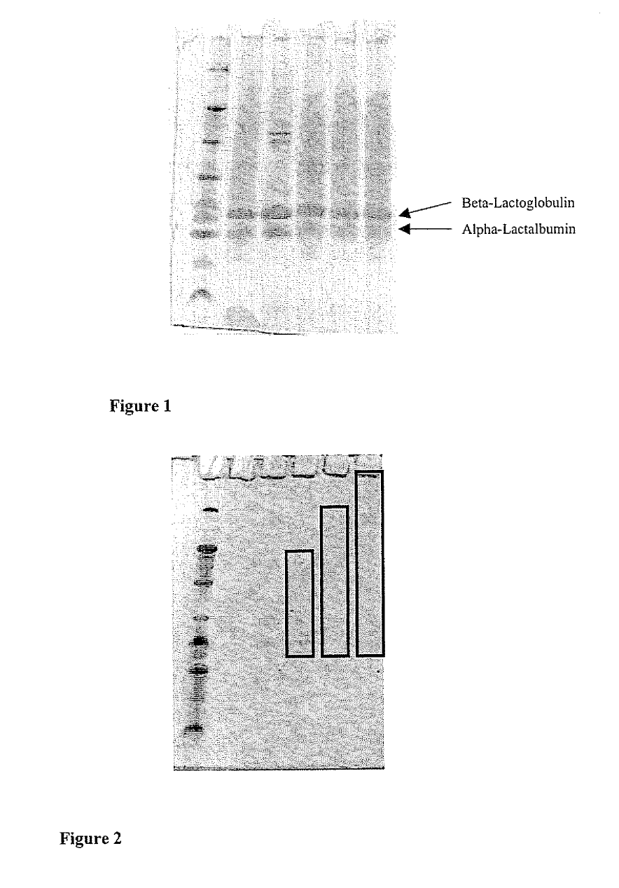

SDS-PAGE results also confirmed covalent coupling of MWPC to dextran under these experimental conditions (FIG. 1). Upon visualization of the gel, characteristic whey protein bands, such as α-lactalbumin (MW: 14 kDa), and β-lactoglobulin (MW: 17 kDa) were observed. The presence of residual α-lactalbumin, and β-lactoglobulin bands indicated that some amount of these proteins remain unreacted with carbohydrate (FIG. 1). Most likely, this response was due in part to the large size of the polysaccharide. A smaller sugar, such as glucose, lactose or ribose, might bind more readily to form the MWPC-carbohydrate complex as compared to a more bulky dextran molecule.

FIG. 2 depicts the SDS-PAGE glycoprotein banding patterns of MWPC and MWPC-Dextran. Electrophoresis results of MWPC-Dextran revealed a smeared carbohydrate staining band, evidence of decreased mobility because of the increased molecular size of the conjugate. This pattern may be due to the formation of lower molecular weight carbohydrates present in dextran caused by acid hydrolysis of the sugars as a result of phosphoric acid present in the MWPC (FIG. 2, lanes 4, 5, 6). Previously, Shepherd et al., supra, used SDS-PAGE techniques to confirm conjugation between casein-maltodextrin. Kato et al., supra, also showed linkage between egg white protein and galactomannan while Ho, Yu-T.; Ishizaki, S.; Tanaka, M. Improving emulsifying activity of ε-polylysine by conjugation with dextran through Maillard reaction. Food Chem., 2000, 68, 449-455, established the covalent attachment between ε-polylysine and dextran via the Maillard reaction. While covalent coupling between sodium caseinate-maltodextrin was recently reported by Morris et al., supra, Neirynck et al., supra, showed an improved emulsion stability of whey protein isolate covalently linked with pectins.

Based on these results, the next series of experiments were designed to evaluate MWP-CHO reaction products obtained using a dextran solution, mixed in a 2:1 ratio with modified whey protein (7% protein in deionized water). Previously, Alkhtar and Dickinson, supra, described the emulsifying properties of whey protein-dextran conjugates at low pH using different salt concentrations. Also, Shepherd et at, supra, showed that casein-maltodextrin linkages were formed after dry heat treatment of freeze dried samples of protein and polysaccharides samples. Mishra et al., supra, studied functional improvement of whey protein concentrate after coupling with pectin (ratio of 1:1) and adjustment of the solution pH to 7.00, freeze drying, and dry heat treatment. Their data showed that whey protein-pectin complexes exhibited improved solubility, emulsifying properties, and foaming characteristics as compared to whey protein alone. Enhanced solubility, heat stability, emulsifying, and foaming capacity were previously noted using glycosylated β-Lg protein solutions (see Chevalier, F.; Chobert, J. M.; Dalgarrondo, M.; Haertle, T. Characterization of the Maillard reaction products of β-lactoglobulin glucosylated in mild conditions. J. Food Biochem., 2001, 25, 33-55.). Hattori, M.; Yang, W.; Takahashi, K. Functional changes of carboxymethyl potato starch by conjugation with whey proteins. J. Agric. Food Chem., 1995, 43, 2007-2011 described a decrease in the swelling properties of potato starch after conjugation with whey proteins using carbodiimide. Kato, A.; Minakei, K.; Kobayashi, K. Improvement of emulsifying properties of egg white proteins by the attachment of polysaccharide through Maillard reaction in a dry state. J. Agric. Food Chem., 1993, 41, 540-543 reported improved characteristics in dried egg white glycoprotein preparations obtained via the Maillard reaction. All of these conjugates were formed in the absence of high moisture. The preparation of MWP-CHO complexes under wet heating conditions may also be suitable but heating times may be greater.

### EXAMPLE 7

### Rheological Analysis

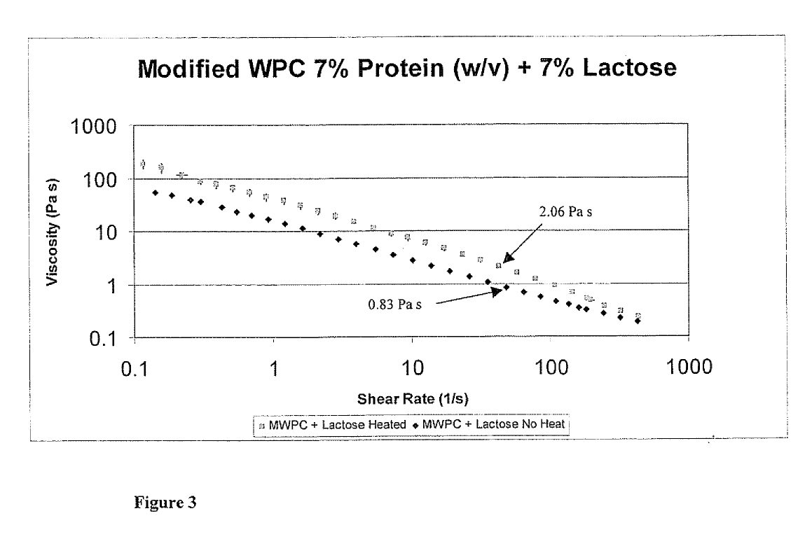

Rheological analysis was performed to identify possible relationships between microstructure and functionality (see Steffe, J. F. Rheological methods in food processing, 2^{nd} edition; Freeman Press: East Lansing, Mich., 1996; p 418). Glycoprotein complexes purportedly have a larger hydrodynamic radius than independent MWPC, and this difference was especially apparent after heating in the presence of lactose, where a two-fold increase in viscosity occurred (FIG. 3). As a result of this increased molecular size, the complex could induce stabilizing functionality at lower concentrations than MWP itself. In other words, complexing lowers the effective concentration required to achieve equivalent functionality. Laneuville et al., supra, reported a similar flow curve with respect to whey protein-xanthan gum complex formation. On the other hand, flow curves from 7% protein (w/v) dispersions of MWPC-Dextran conjugates were conducted to determine stability over the shear rate range of 0.1-500 s⁻¹ at 25° C. with a serrated bob and cup geometry and showed no significant increase in viscosity (not shown). All samples were analyzed in triplicate. Based on these results desired functionality dictates which carbohydrates may be most suitable for the application.

### EXAMPLE 8

### Scanning Electron Microscopy

MWPC and MWPC-Dextran preparations were visualized using scanning electron microscopy. All samples were placed in a 78 μm microporous capsule (Structure Probe Inc., West Chester, Pa.). The capsule was left in 2 ml of cold 3% glutaraldehyde buffered to pH 3.5 with a 0.1M sodium acetate buffer for 24 hours. After 24 hours, the capsule was transferred to a Petri dish containing 0.1M sodium acetate buffer. The liquid whey sample had formed a solid mass enabling it to be cut into 2-3 mm³ pieces. The 2-3 mm³ pieces were then washed 3 times with 0.1M sodium acetate buffer for 20 minutes at 4° C. Dehydration steps were then performed using an ethanol series of 30%, 50%, 70%, 95% and 100% for 20 minutes at 4° C. A Samdri-795 (Tousimis, Rockville, Md.) was then used for critical point drying of the samples. A 25-30 nm coating of gold/palladium was applied to the samples using an Anatech Hummer 6.2 sputter coater (Anatech Ltd, Denver, N.C.).

### EXAMPLE 9

### Microscopy

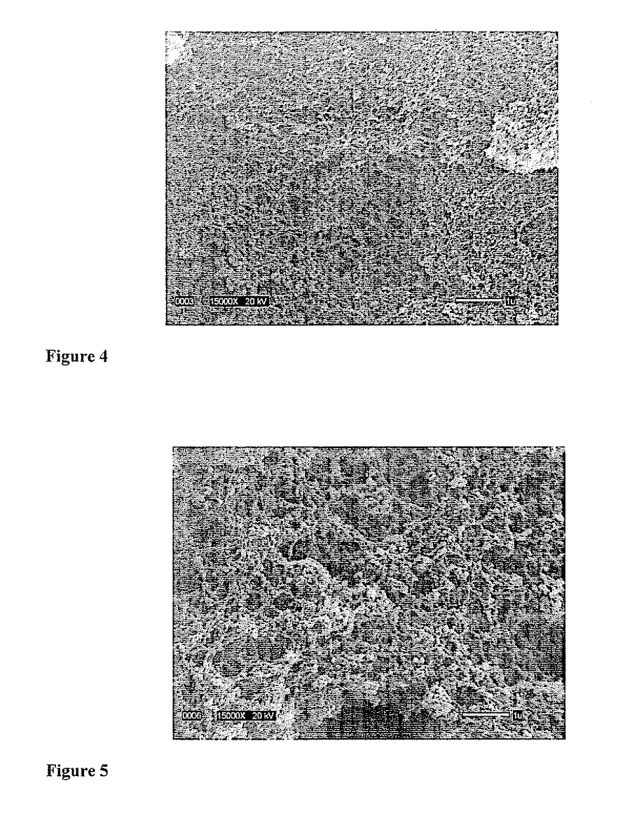

Electron micrographs of the modified protein revealed a fibrillar network of polymerized whey proteins and a non-homogeneous particulate structure (FIG. 4). In contrast, MWP-Dextran evidenced a more porous non-homogeneous microstructure likely due to the higher molecular weight of dextran (FIG. 5). Previously, Matsudomi et al., supra, showed that covalent coupling of an egg-white, dextran mixture produced a non-homogeneous gel microstructure.

### EXAMPLE 10

### Emulsion Stability

The ability of the MWP and MWP-Dextran conjugate to stabilize an emulsion was evaluated by measuring the creaming index. Stock solutions containing 5 mg/ml protein (MWPC, glyco-conjugate, Ultra 8000) were made in DI water. The solutions were stirred for 2 hours at 150 rpm and allowed to hydrate overnight at 4° C. Sodium azide 0.02% (w/v) was added to the solutions to prevent microbial growth. The pH of each solution was measured to ensure that values were at an established pH of 3.5. The solutions were then blended at a 1:1 ratio with corn oil in a Waring blender on the highest setting for approximately 1 minute. The solutions were immediately homogenized in 2 passes using a Savpro homogenizer at a setting of 200 bar on stage 1 to form an emulsion. Particle size analysis was performed on each sample to ensure that the droplet sizes were in the same range and near the ideal size of 1 μm.

The stability of the emulsions was assessed based on evaluation of a creaming index as established by Demetriades and McClements (1999). Ten milliliters of each emulsion was placed in a 15 mL centrifuge tube (Fisher Scientific, USA) and stored at ambient temperature for a period of one week and subsequently measured. Each sample separated into two layers with a droplet rich layer on top and droplet depleted layer on the bottom. The total height of each emulsion (HE) and the height of the droplet depleted layer (HD) were measured in triplicate. The creaming index was reported as:

$$Creaming Index = 100 \times ( \frac{HD}{HE} ) \qquad ( 1.0 )$$

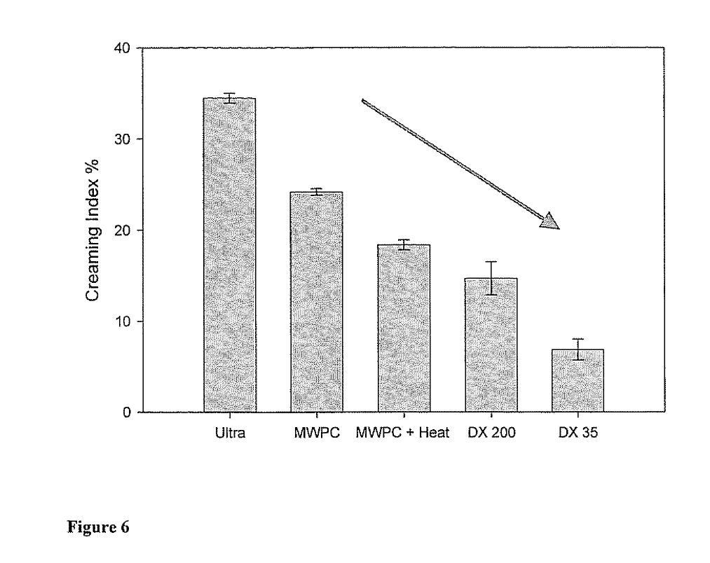

The MWP-Dextran conjugates increased stabilization by 71% and 82% over the MWP and a commercial WP respectively (FIG. 6). Askhtar and Dickinson saw similar improvements through the conjugation of an unmodified whey protein and maltodextrin.

In conclusion, non-enzymatically generated MWP-CHO complex formation was confirmed using color analysis, electrophoretic techniques, rheological measurements, and scanning electron microscopy. Glycoprotein formation between modified whey proteins with either dextran or lactose, was established. Ultimately, this dairy-based food component may function as a low-carbohydrate, high-protein stabilizer and emulsifier for use in commercial food processing applications.

Many modifications and other embodiments of the inventions set forth herein will come to mind to one skilled in the art to which this invention pertains having the benefit of the teachings presented in the foregoing descriptions and associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. A process for producing a protein-carbohydrate complex, comprising the steps of:
providing a modified protein (MP), the MP characterized by being denatured and heated sufficiently to gel;
mixing the MP with a carbohydrate to form an MP-carbohydrate mixture; and
heating the MP-carbohydrate mixture to a temperature and for a time sufficient to form MP-carbohydrate complexes.

2. The process defined in claim 1, wherein the mixing and heating steps are carried out in the absence of enzymatic agents.

3. The process defined in claim 1, wherein the MP has a viscosity of at least one-half Pa-s at 46 s⁻¹ for one half hour in a steady state shear test at 25° C. when reconstituted as a 10% weight/weight solution in deionized water at a pH of 4.

4. The process defined in claim 1, wherein the MP has a phase angle of five to forty degrees at frequencies of from 0.01 to 20 Hertz in a frequency sweep test at 25° C. when reconstituted as a 10% weight/weight solution in deionized water.

5. The process defined in claim 1, wherein the heating step comprises heating the MP-carbohydrate mixture to a temperature of at least 60° C.

6. The process defined in claim 1, wherein the heating step comprises heating the MP-carbohydrate mixture for a duration of at least 2 hours.

7. The process defined in claim 1, wherein the mixing step comprises mixing the MP with the carbohydrate at an acidic pH.

8. The process defined in claim 1, wherein the mixing step comprises mixing the MP with the carbohydrate at a pH of between about 3 and 4.

9. The process defined in claim 1, wherein the mixing step comprises mixing the MP with the carbohydrate at a pH of between about 3.3 and 3.6.

10. The process defined in claim 1, further comprising the step of forming the MP-carbohydrate complexes into a powder.

11. The process defined in claim 1, wherein the MP-carbohydrate complexes have a viscosity of at least 1.0 Pa-s at a shear rate of a 50 s⁻¹ at 25° C.

12. The process defined in claim 1, wherein the MP-carbohydrate complexes have a creaming index of less than 25 percent.

13. The process defined in claim 1, wherein the MP-corrector complexes have a creaming index of less than 15 percent.

14. The process defined in claim 1, wherein the MP is provided in an aqueous solution.

15. The process defined in claim 1, wherein the carbohydrate is selected from the group consisting of lactose, corn syrup and dextran.

16. The process defined in claim 1, further comprising the step of adding the MP-carbohydrate complexes to a foodstuff prior to packaging of the foodstuff.

17. The process defined in claim 1, wherein the heating step comprises forming a covalent bond between the MP and a reducing end of the carbohydrate.

18. The process defined in claim 1, wherein the heating step induces a Maillard reaction between the MP and the carbohydrate.

19. The process defined in claim 1, wherein mixing step comprises mixing the MP and the carbohydrate in a ratio between 1:1 and 3:1 by weight.

20. The process defined in claim 13, wherein the ratio is between about 1.5:1 and 2.5:1.

21. The process defined in claim 1, wherein the MP is whey protein.

22. The MP-carbohydrate complex formed by the process of claim 1.

23. A modified protein (MP)-carbohydrate complex having a viscosity of at least 1.0 Pa-s at a shear rate of a 50 s⁻¹ at 25° C. and a creaming index of less than 25 percent.
